(19) United States
(12) Patent Application Publication
(10) Pub. No.: US 2023/0026626 A1
(43) Pub. Date: Jan. 26, 2023

(54) ROUTE INFORMATION STORAGE METHOD AND APPARATUS

(71) Applicant: HUAWEI TECHNOLOGIES CO., LTD., Shenzhen (CN)

(72) Inventors: Rahul Arvind JADHAV, Bangalore (IN); Qiangde XIE, Shenzhen (CN); Jing ZUO, Shenzhen (CN)

(21) Appl. No.: 17/955,698

(22) Filed: Sep. 29, 2022

Related U.S. Application Data
(63) Continuation of application No. PCT/CN2021/081230, filed on Mar. 17, 2021.

(30) Foreign Application Priority Data
Mar. 31, 2020 (CN) 202010249296.6

(51) Int. Cl. H04L 45/745; H04L 45/24; H04L 45/42

(52) U.S. Cl. CPC H04L 45/745; H04L 45/24; H04L 45/42

(57) ABSTRACT

This application discloses a route information storage method. The method is applied to a wireless mesh network, the wireless mesh network includes a first node, a second node, and at least two stations STAs, the first node is an upper-level node of the second node, the at least two STAs include a first STA and a second STA, and the first STA and the second STA are connected to the second node. In the method, the first node receives a routing request for access requested by the first STA, and if it is determined that a first route entry corresponding to the second STA already exists, the first node no longer generates a new route entry for the first STA, but reuses the first route entry.

### CROSS-REFERENCE TO RELATED APPLICATIONS

This application is a continuation of International Application No. PCT/CN2021/081230, filed on Mar. 17, 2021, which claims priority to Chinese Patent Application No. 202010249296.6, filed on Mar. 31, 2020. The disclosures of the aforementioned applications are hereby incorporated by reference in their entireties.

### TECHNICAL FIELD

This application relates to the field of communication technologies, and specifically, to a route information storage method and apparatus.

### BACKGROUND

A wireless network is an important part of the internet of things. In a conventional wireless network connection manner, all devices that need to communicate need to access a fixed access point (AP) for communication. This network structure is referred to as a single-hop network. A wireless mesh network is a multi-hop network. In the wireless mesh network, each node may simultaneously serve as an AP and a router, each node in the network may send and receive a signal, and each node may directly communicate with one or more peer nodes.

An existing wireless mesh network generally includes a mesh border router (MBR) used as a root node, a mesh gate (MG) used as an intermediate node, and a mesh station (STA) used as an end node. In order to maintain communication routes between nodes, each MG and the MBR generally need to maintain a route table to manage routes to other nodes. As a number of connected devices increases, a network scale becomes larger, and the route table becomes larger, occupying more memory space. However, memory resources of internet of things devices are usually limited, and cannot support route cache and maintenance on large-scale networking.

### SUMMARY

Embodiments of this application provide a route information storage method, to reduce a buffer space occupied by buffered route information. This application further provides a corresponding apparatus.

A first aspect of this application provides a route information storage method, where the method is applied to a mesh network. The mesh network includes a first node, a second node, and at least two stations (STAs), the first node is an upper-level node of the second node, the at least two STAs include a first STA and a second STA, and the first STA and the second STA are connected to the second node. The method includes: The first node receives a routing request from the second node, where the routing request is used for requesting the first STA to access the first node, and the routing request includes a first identifier for indicating the second node; the first node determines, based on the first identifier, a first route entry corresponding to a station connected to the second node, where the first route entry corresponds to the second STA; and the first node reuses the first route entry as a route entry of the first STA.

In the first aspect, the mesh network may communicate with the Internet through a routing device, and the mesh network may be a subnet of the routing device. Both the first node and the second node are devices having forwarding functions. The first node may be a mesh border router (MBR), or may be a mesh gate (MG), and the second node may be an MG. If both the first node and the second node are MGs, the first node is located at an upper level of the second node. The first identifier of the second node is associated with the first route entry, and the first route entry may be found based on the first identifier. A route entry is a piece of route information stored in a form of a target address. When different STAs connected to the same second node access the first node or communicate with the Internet, corresponding data needs to pass through a path between the first node and the second node. Therefore, on the first node, the STAs connected to the same second node may reuse a same route entry on the first node. Reusing indicates that an existing route entry is used, and a new route entry is no longer generated for the first STA. It may alternatively be understood that respective route entries of the STAs connected to the same second node may be stored in an aggregated manner on the first node. For example, the first STA reuses a route entry of the second STA, which may be understood as: A route entry of the first STA and a route entry of the second STA are stored in an aggregated manner. Regardless of how many STAs are connected to the second node, the first node may store only one route entry for the STAs, so that data of the STAs can be transmitted from the first node to the second node. It can be learned from the first aspect that, for the at least two STAs under the same second node, the same first route entry may be reused on the first node, and only one route entry needs to be stored for all the STAs under the same second node. This reduces storage space occupied for storing route entries of the STAs.

In a possible implementation of the first aspect, the foregoing step in which the first node determines, based on the first identifier, a first route entry corresponding to a station connected to the second node includes: The first node generates a first prefix based on the first identifier and at least a part of an address of the second node; and the first node determines, based on the first prefix, the first route entry corresponding to a station connected to the second node, where the first route entry includes a field the same as the first prefix.

In this possible implementation, the address of the second node may be an internet protocol version 6 (internet protocol version 6, IPv6) address of the second node, and the at least a part of the address of the second node may be an IPv6 64-bit prefix. The first identifier may be a random value, and the random value may have 8 bits. The at least a part of the address of the second node may be combined with the first identifier in a serial combination manner, to obtain the first prefix. Certainly, the first prefix may further include another field, for example, an anti-collision field for preventing a collision between the first prefix and an existing IPv6 address. For example, MNID 2 represents the first identifier, 0xff represents the anti-collision field, and then the first prefix (prefix) may be represented as: The IPv6 address prefix of the second node (64 bits)+0xff (8 bits)+MNID 2 (8 bits), where “+” indicates string concatenation. Certainly, this is only a representation manner. Actually, a sequence of the concatenated character strings may be changed, and bits of each character may be extended or reduced, or other information may be added. For example, the first prefix may further include a reserved field, and the reserved field is used for subsequently extending the identifier of the second node when there are an excessively large quantity of second nodes in the mesh network. In this possible implementation, the first prefix is generated to indicate the second node, so that a route entry can be quickly found.

In a possible implementation of the first aspect, the foregoing step in which the first node determines, based on the first identifier, a first route entry corresponding to a station connected to the second node includes: The first node searches a route table based on the first identifier, to determine the first route entry corresponding to a station connected to the second node, where a target address field of the first route entry includes the first identifier.

In this possible implementation, the route table stores route entries of nodes, and each route entry includes a target address field. The first prefix in the foregoing implementation may be located in the target address field. If the target address field of the first route entry includes the first identifier, it indicates that the first route entry is a route entry of the STAs under the second node. In this possible implementation, the first route entry is searched based on the first identifier, so that a route entry can be quickly found.

In a possible implementation of the first aspect, the first identifier uniquely identifies the second node in the mesh network.

In a possible implementation of the first aspect, the first identifier is located in a node identifier field of the first route entry.

In this possible implementation, a node identifier field may be extended in the first route entry, and the node identifier field stores the first identifier of the second node.

In a possible implementation of the first aspect, the first identifier is located in an option (option) field of the routing request.

In this possible implementation, the routing request may be extended, and an option field is re-extended in the routing request, to store the first identifier.

In a possible implementation of the first aspect, the first node is a mesh border router MBR, and the method further includes: The MBR allocates the first identifier to the second node; and the MBR generates a second route entry from the MBR to the second node, where the second route entry includes the first identifier.

In this possible implementation, in a wireless mesh network, the MBR communicates with a router in the Internet, and the MBR may also be referred to as a root node in the wireless mesh network. The MBR may allocate a mesh node identifier (mesh node identifier, MNID) to each second node connected to the MBR, and the MBR may also allocate an MNID to the MBR. These MNIDs are different from each other. In this way, each MNID uniquely identifies a corresponding node in the mesh network of the root node. After allocating the first identifier to the second node, the MBR generates a second route entry corresponding to the second node. In this way, when there is data to be sent to the second node, the second route entry may be used to send the data.

In a possible implementation of the first aspect, the first node is a mesh gate MG, and the method further includes: The MG receives the first identifier from a mesh border router MBR; and the MG generates a third route entry from the MG to the second node, where the third route entry includes the first identifier.

In this possible implementation, in a wireless mesh network, a STA may communicate with the MBR through one MG or through two or more MGs. In other words, the MG may be hierarchical. When the MG is hierarchical, the second node is a lowest-level MG connected to the STA, the first node may be an upper-level MG of the second node, and an MBR may be above the upper-level MG, or another upper-level MG may be above the upper-level MG. A specific quantity of levels is not limited in this application. After receiving the first identifier from the MBR, the upper-level MG generates the third route entry. In this way, when there is data to be sent to the second node, the third route entry may be used to send the data.

In a possible implementation of the first aspect, the method further includes: The first node restarts before receiving the routing request; and the first node replaces the first identifier with a second identifier after receiving the routing request from the second node.

In this possible implementation, the wireless mesh network is used as an example. Considering that the MBR may be restarted due to a fault, generally, after the MBR is restarted, a unique identifier is reallocated to each second node under the MBR. Regardless of whether the first node is an MBR or an MG, after obtaining a new unique identifier, the first node uses the new unique identifier to update a corresponding route entry. In this case, if the second node still uses an original first identifier when sending the routing request, after receiving the routing request, the first node replaces the first identifier with a reallocated new second identifier, and then uses the second identifier to perform a subsequent corresponding step of searching for a route entry. This possible implementation can avoid a problem that a route entry cannot be searched after an MBR is restarted.

In a possible implementation of the first aspect, the method further includes: The first node receives a first downlink packet and a second downlink packet, where the first downlink packet includes a media access control (media access control, MAC) address of the first STA and a second prefix, the second downlink packet includes a MAC address of the second STA and the second prefix, and the second prefix is the same as content of the target address field of the first route entry; the first node determines, based on the second prefix, the first route entry reused by the first STA and the second STA; and the first node sends the first downlink packet and the second downlink packet to the second node based on the first route entry.

In this possible implementation, for downlink packets sent to different STAs, the first node may use a same route entry for sending, and the first node needs to store only one route entry for the different STAs. This reduces storage space occupied for storing route entries of the STAs.

A second aspect of this application provides a packet sending method, where the method is applied to a mesh network, the mesh network includes a first node, a second node, and at least two STAs, the first node is an upper-level node of the second node, the at least two STAs include a first STA and a second STA, and the first STA and the second STA are connected to the second node. The method includes: The first node receives a first downlink packet and a second downlink packet, where the first downlink packet includes a media access control (media access control, MAC) address of the first STA and a second prefix, the second downlink packet includes a MAC address of the second STA and the second prefix, and the second prefix is the same as content of a target address field of a first route entry; the first node determines, based on the second prefix, the first route entry reused by the first STA and the second STA, where the first route entry corresponds to each STA under the second node; and the first node sends the first downlink packet and the second downlink packet to the second node based on the first route entry.

In the second aspect, for downlink packets sent to different STAs connected to the same node (the second node), the first node may use a same route entry for sending, and the first node needs to store only one route entry for the different STAs. This reduces storage space occupied for storing route entries of the STAs.

In a possible implementation of the second aspect, the foregoing step in which the first node determines, based on the second prefix, the first route entry reused by the first STA and the second STA includes: The first node searches target address fields in a route table based on the second prefix, to determine the first route entry whose content of the target address field is the same as the second prefix.

A third aspect of this application provides a route information storage apparatus. The route information storage apparatus has a function of implementing the method in any one of the first aspect or the possible implementations of the first aspect. The function may be implemented by hardware or may be implemented by hardware by executing corresponding software. The hardware or software includes one or more modules corresponding to the foregoing function, for example, a receiving unit, a determining unit, a reusing unit, an allocation unit, a first generation unit, a second generation unit, a restarting unit, a replacement unit, and a sending unit.

A fourth aspect of this application provides a packet sending apparatus. The packet sending apparatus has a function of implementing the method in any one of the second aspect or the possible implementations of the second aspect. The function may be implemented by hardware or may be implemented by hardware by executing corresponding software. The hardware or software includes one or more modules corresponding to the foregoing function, for example, a receiving unit, a determining unit, and a sending unit.

A fifth aspect of this application provides a computer device, where the computer device includes a processing circuit and a computer-readable storage medium storing a computer program, the processing circuit is coupled to the computer-readable storage medium, and when the computer program is executed by the processing circuit, the processing circuit performs the method according to any one of the first aspect or the possible implementations of the first aspect.

A sixth aspect of this application provides a computer device, where the computer device includes a processing circuit and a computer-readable storage medium storing a computer program, the processing circuit is coupled to the computer-readable storage medium, and when the computer program is executed by the processing circuit, the processing circuit performs the method according to any one of the second aspect or the possible implementations of the second aspect.

A seventh aspect of this application provides a computer-readable storage medium storing one or more computer-executable instructions. When the computer-executable instructions are executed by a processing circuit, the processing circuit performs the method according to any one of the first aspect or the possible implementations of the first aspect.

An eighth aspect of this application provides a computer-readable storage medium storing one or more computer-executable instructions. When the computer-executable instructions are executed by a processing circuit, the processing circuit performs the method according to any one of the second aspect or the possible implementations of the second aspect.

A ninth aspect of this application provides a computer program product storing one or more computer-executable instructions. When the computer-executable instructions are executed by a processing circuit, the processing circuit performs the method according to any one of the first aspect or the possible implementations of the first aspect.

A tenth aspect of this application provides a computer program product storing one or more computer-executable instructions. When the computer-executable instructions are executed by a processing circuit, the processing circuit performs the method according to any one of the second aspect or the possible implementations of the second aspect.

An eleventh aspect of this application provides a chip system. The chip system includes a processing circuit, configured to support a route information storage apparatus in implementing functions in any one of the first aspect or the possible implementations of the first aspect. In a possible design, the chip system may further include a memory. The memory is configured to store program instructions and data that are necessary for the route information storage apparatus. The chip system may include a chip, or may include a chip and another discrete component.

A twelfth aspect of this application provides a chip system. The chip system includes a processing circuit, configured to support a packet sending apparatus in implementing functions in any one of the second aspect or the possible implementations of the second aspect. In a possible design, the chip system may further include a memory. The memory is configured to store program instructions and data that are necessary for the packet sending apparatus. The chip system may include a chip, or may include a chip and another discrete component.

For technical effects brought by any one of the third aspect, the fifth aspect, the seventh aspect, the ninth aspect, and the eleventh aspect or the possible implementations thereof, refer to the technical effects brought by the first aspect or the different possible implementations of the first aspect. Details are not described herein again.

For technical effects brought by any one of the fourth aspect, the sixth aspect, the eighth aspect, the tenth aspect, and the twelfth aspect or the possible implementations thereof, refer to the technical effects brought by the second aspect or the different possible implementations of the second aspect. Details are not described herein again.

In embodiments of this application, for the at least two STAs under the same second node, the same first route entry may be reused on the first node, and only one route entry needs to be stored for all the STAs under the same second node. This reduces storage space occupied for storing route entries of the STAs.

### BRIEF DESCRIPTION OF DRAWINGS

FIG. 1 is a schematic diagram of a network communication architecture according to an embodiment of this application;

FIG. 2 is a schematic diagram of a structure of a mesh network according to an embodiment of this application;

FIG. 3 is a schematic diagram of an embodiment of a route information storage method according to an embodiment of this application;

FIG. 4 is a schematic diagram of an example scenario according to an embodiment of this application;

FIG. 5 is a schematic diagram of another example scenario according to an embodiment of this application;

FIG. 6 is a schematic diagram of another example scenario according to an embodiment of this application;

FIG. 7 is a schematic diagram of another example scenario according to an embodiment of this application;

FIG. 8 is a schematic diagram of another example scenario according to an embodiment of this application;

FIG. 9 is a schematic diagram of an embodiment of a packet sending method according to an embodiment of this application;

FIG. 10 is a schematic diagram of an example scenario of a packet sending method according to an embodiment of this application;

FIG. 11 is a schematic diagram of an embodiment of a route information storage apparatus according to an embodiment of this application;

FIG. 12 is a schematic diagram of an embodiment of a packet sending apparatus according to an embodiment of this application; and

FIG. 13 is a schematic diagram of an embodiment of a computer device according to an embodiment of this application.

### DESCRIPTION OF EMBODIMENTS

The following describes embodiments of this application with reference to the accompanying drawings. It is clear that the described embodiments are merely some but not all of embodiments of this application. A person of ordinary skill in the art may learn that the technical solutions provided in embodiments of this application are also applicable to a similar technical problem as a technology develops and a new scenario emerges.

In the specification, claims, and accompanying drawings of this application, the terms “first”, “second”, and so on are intended to distinguish between similar objects but do not necessarily indicate a specific order or sequence. It should be understood that the data termed in such a way are interchangeable in proper circumstances so that embodiments described herein can be implemented in other orders than the order illustrated or described herein. In addition, the terms “include”, “contain” and any other variants mean to cover the non-exclusive inclusion, for example, a process, method, system, product, or device that includes a list of steps or units is not necessarily limited to those expressly listed steps or units, but may include other steps or units that are not expressly listed or that are inherent to such a process, method, system, product, or device.

Embodiments of this application provide a route information storage method, to reduce buffer space occupied by buffered route information. This application further provides a corresponding apparatus. Details are separately described below.

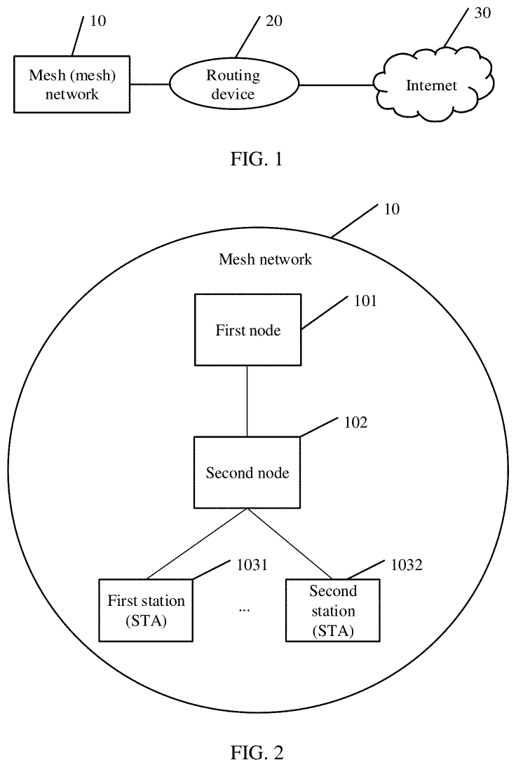

A route information storage method provided in embodiments of this application may be applied to a mesh (mesh) network. As shown in a schematic diagram of a network communication architecture shown in FIG. 1, the mesh network 10 may communicate with the Internet 30 through a routing device 20, and the mesh network may be a subnet of the routing device. The mesh network may be applied to a plurality of internet of things (internet of things, IoT) scenarios such as smart parking space monitoring, water meter monitoring, electric meter monitoring, and smart household in a parking lot.

FIG. 2 is a schematic diagram of a structure of a mesh network according to an embodiment of this application.

As shown in FIG. 2, the mesh network includes a first node 101, a second node 102, and stations (stations, STAs). At least two STAs are connected to the second node 102, and the at least two STAs include a first STA 1031 and a second STA 1032. For example, the mesh network is a wireless mesh network. The first node may be a mesh border router (mesh border router, MBR), or may be a mesh gate (Mesh Gate, MG), and the second node may be an MG. If both the first node and the second node are MGs, the first node is located at an upper level of the second node.

The MBR is responsible for route maintenance of the wireless mesh network, and is directly connected to the routing device 20 in FIG. 1. The MBR may be connected to the Internet 30 through the routing device 20. Therefore, if an MG or a STA in the wireless mesh network wants to communicate with the Internet, the MG or the STA needs to use the MBR, that is, the MBR needs to maintain information about routes to all MGs or STAs.

The MG is responsible for forwarding a data packet. A network with two levels of MGs is used as an example. A first-level MG is connected to a second-level MG, and the second-level MG is connected to a STA. Therefore, the first-level MG also needs to maintain information about routes to another second-level MG and the STA.

The STA is the last-hop node and generally does not have a data forwarding function.

The MBR and the MG generally support a routing protocol for low-power and lossy networks (routing protocol for Low-Power and lossy networks, RPL). A request sent by the MG to the MBR is generally a destination advertisement object (destination advertisement object, DAO) request, and an acknowledgment (acknowledgment, ACK) sent by the MBR to the MG is generally a DAO-ACK or a grounded acknowledgment (grounded acknowledgment, GACK).

The STA generally supports a router solicitation/router advertisement (router solicitation/router advertisement, RS/RA).

After the second node 102 and each STA under the second node 102 access the first node 101, the first node 101 stores route entries to the second node and to the STAs, where a route entry is a piece of route information stored in a form of a target address. In this embodiment of this application, only one route entry is stored for the STAs under the second node 102, and each STA under the second node 102 reuses the route entry. Reusing indicates that an existing route entry is used, and a new route entry is no longer generated for the first STA. It may alternatively be understood that respective route entries of the STAs connected to the same second node 102 may be stored in an aggregated manner on the first node. For example, the first STA reuses a route entry of the second STA, which may be understood as: A route entry of the first STA and a route entry of the second STA are stored in an aggregated manner.

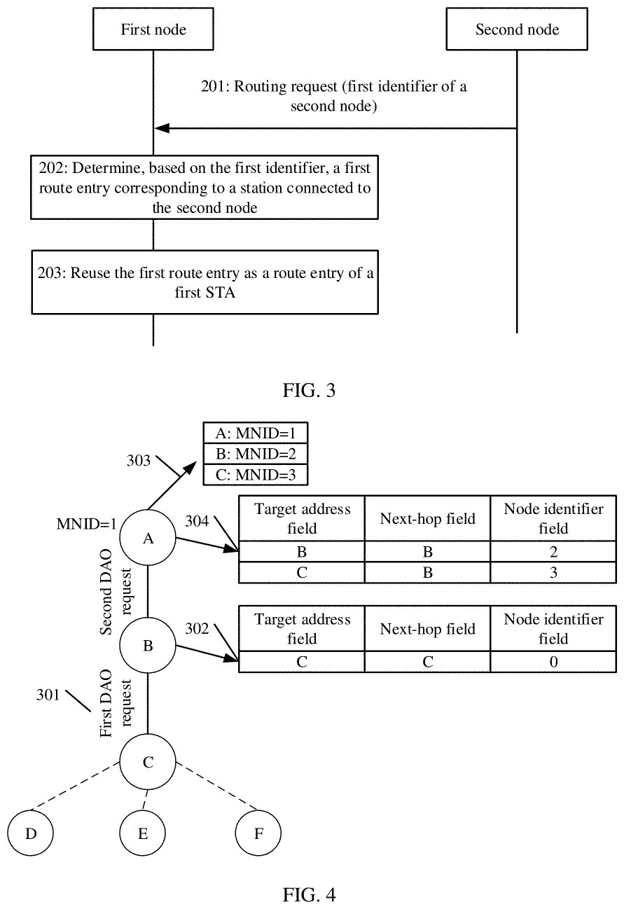

The foregoing implementation process of reusing the same route entry by the STAs under the second node 102 may be understood with reference to a schematic diagram of an embodiment of a route information storage method shown in FIG. 3.

As shown in FIG. 3, an embodiment of a route information storage method provided in an embodiment of this application may include the following steps.

201: A first node receives a routing request from a second node.

The routing request is used for requesting a first STA to access the first node. The routing request includes a first identifier for indicating the second node.

The routing request may be a DAO request.

Optionally, the first identifier uniquely identifies the second node in the mesh network. The first identifier may be located in an option (option) field of the routing request. The option field may be implemented by extending the routing request, or may be implemented by using an idle field in the routing request.

202: The first node determines, based on a first identifier, a first route entry corresponding to a station connected to the second node.

The first route entry is generated for a STA that is the first one accessing the first node and that is under the second node. The first route entry corresponds to a second STA. If the second STA is the STA that is the first one accessing the first node and that is under the second node, the first route entry is generated for the second STA. If the second STA is not the STA that is the first one accessing the first node and that is under the second node, the first node reuses the first route entry as a route entry of the second STA.

The first route entry includes a target address field, and the target address field includes the first identifier. Therefore, the first route entry may be determined based on the first identifier.

203: The first node reuses the first route entry as a route entry of a first STA.

In embodiments of this application, for the at least two STAs under the same second node, the same first route entry may be reused on the first node, and only one route entry needs to be stored for all the STAs under the same second node. This reduces storage space occupied for storing route entries of the STAs.

Optionally, the foregoing step 202 of determining the first route entry may be implemented by using the following two solutions.

Solution 1: The first node generates a first prefix based on the first identifier and at least a part of an address of the second node; and the first node determines, based on the first prefix, the first route entry corresponding to a station connected to the second node, where the first route entry includes a field the same as the first prefix.

The address of the second node may be an internet protocol version 6 (internet protocol version 6, IPv6) address of the second node, and the at least a part of the address of the second node may be an IPv6 64-bit prefix. The first identifier may be a random value, and the random value may have 8 bits. The at least a part of the address of the second node may be combined with the first identifier in a serial combination manner, to obtain the first prefix. Certainly, the first prefix may further include another field, for example, an anti-collision field for preventing a collision between the first prefix and an existing IPv6 address. For example, a mesh node identifier (mesh node identifier, MNID) represents the first identifier, 0xff represents the anti-collision field, and then the first prefix (prefix) may be represented as: The IPv6 address prefix of the second node (64 bits)+0xff (8 bits)+MNID (8 bits), where “+” indicates string concatenation. Certainly, this is only a representation manner. Actually, a sequence of the concatenated character strings may be changed, and bits of each character may be extended or reduced, or other information may be added. For example, the first prefix may further include a reserved field, and the reserved field is used for subsequently extending the identifier of the second node when there are an excessively large quantity of second nodes in the mesh network.

The first route entry may be understood by using a route table shown in the following Table 1:

TABLE 1
Route table including a first route entry

| Target address field | Next-hop field | Node identifier field |
|---|---|---|
| Prefix (second node) | Second node | MNID |

The prefix (second node) in the first route entry indicates the prefix of the second node, and the prefix (second node) may include: the IPv6 address prefix of the second node (64 bits)+0xff (8 bits)+MNID (8 bits). The node identifier field may be extended in the first route entry, and the first identifier MNID is located in the node identifier field of the first route entry. Alternatively, the node identifier field may not be extended in the first route entry, and in this case, the first identifier MNID only needs to be stored in a buffer.

The first node may generate the first prefix according to the foregoing rule for generating the first prefix, where the first prefix also includes the IPv6 address prefix of the second node (64 bits)+0xff (8 bits)+MNID (8 bits). In this way, the first route entry may be found in the route table based on the first prefix.

In this possible embodiment, the first prefix is generated to indicate the second node, so that a route entry can be quickly found.

Solution 2: The first node searches a route table based on the first identifier, to determine the first route entry corresponding to a station connected to the second node, where a target address field of the first route entry includes the first identifier.

The route table stores route entries of nodes, and each route entry includes a target address field. In the foregoing solution 1, the prefix (second node) of the target address field in Table 1 includes the first identifier. Therefore, the target address field may be searched based on the first identifier. Because an identifier of each node is unique and all STAs under each node reuse a same route entry, the first route entry may be uniquely found based on the first identifier.

In this possible embodiment, the first route entry is searched based on the first identifier, so that a route entry can be quickly found.

For ease of understanding this application, the following uses a wireless mesh network as an example to describe a route information storage process in this application with reference to an example scenario.

FIG. 4 is a schematic diagram of an example scenario according to an embodiment of this application.

As shown in FIG. 4, in the example scenario, a node A is an MBR, a node B is a first-level MG, a node C is a second-level MG, and D, E, and F are STAs.

301: During initialization, the node C sends a first DAO request, where the first DAO request is used for requesting to establish an A-C route.

302: After receiving the first DAO request, the node B buffers a B-C route entry, and sends a second DAO message to the node A.

In FIG. 4, MNID=0 in the B-C route entry indicates that an MNID value of the node C is not obtained yet.

303: The node A receives the second DAO message, and allocates identifiers.

The MBR has an identifier allocation function. The MBR allocates a different identifier to each of the node B and the node C, and the MBR may also allocate an identifier to the MBR. For example, the identifier allocated by the MBR to the MBR is MNID=1, the identifier allocated to the node B is MNID=2, and the identifier allocated to the node C is MNID=3. Certainly, the identifiers 1, 2, and 3 allocated herein are merely examples for description, the identifier may be a randomly generated value, and a specific value is not limited in this application.

304: The node A generates an A-B/A-C route entry, and stores an MNID value of the node B and an MNID value of the node C in the corresponding route entry.

As shown in FIG. 4, the route table of the node A may be understood with reference to Table 2.

TABLE 2
Route table

| Target address field | Next-hop field | Node identifier field |
|---|---|---|
| Address of a node B | B | 2 |
| Address of a node C | B | 3 |

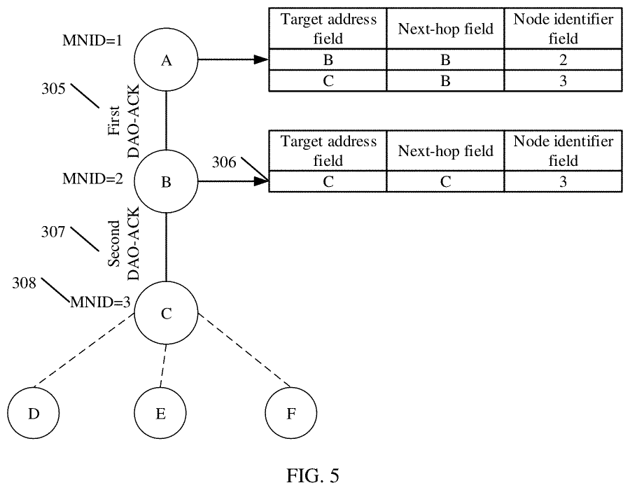

After generating the A-B/A-C route entry, the node A feeds back to the node B. A corresponding process in a downlink direction may be understood with reference to FIG. 5. FIG. 5 shows the following steps.

305: The node A sends a first DAO-ACK to the node B, where the first DAO-ACK includes the MNID value of the node B and/or the MNID value of the node C.

In this embodiment of this application, the identifier of the node B and the identifier of the node C may be separately sent to the node B by using two acknowledgments, or may be sent to the node B by using one acknowledgment. When the identifiers are sent by using one acknowledgment, two option fields may be configured in the acknowledgment, the MNID value of the node B is located in a first option field, and the MNID value of the node C is located in a second option field.

If the node A is a root node, the first DAO-ACK may alternatively be replaced with a GACK.

306: The node B obtains the identifier MNID=2, and updates the MIND value of the node C in the B-C route entry in a route table.

307: The node B sends a second DAO-ACK to the node C, where the second DAO-ACK includes the MNID value of the node C.

308: The node C obtains the identifier MNID=3.

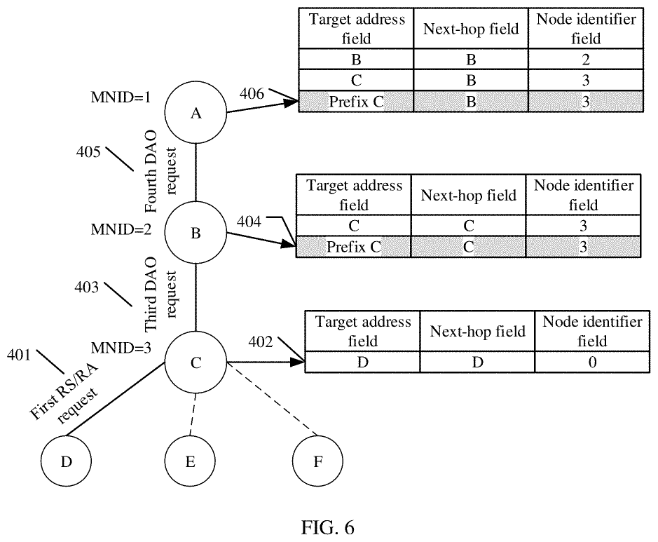

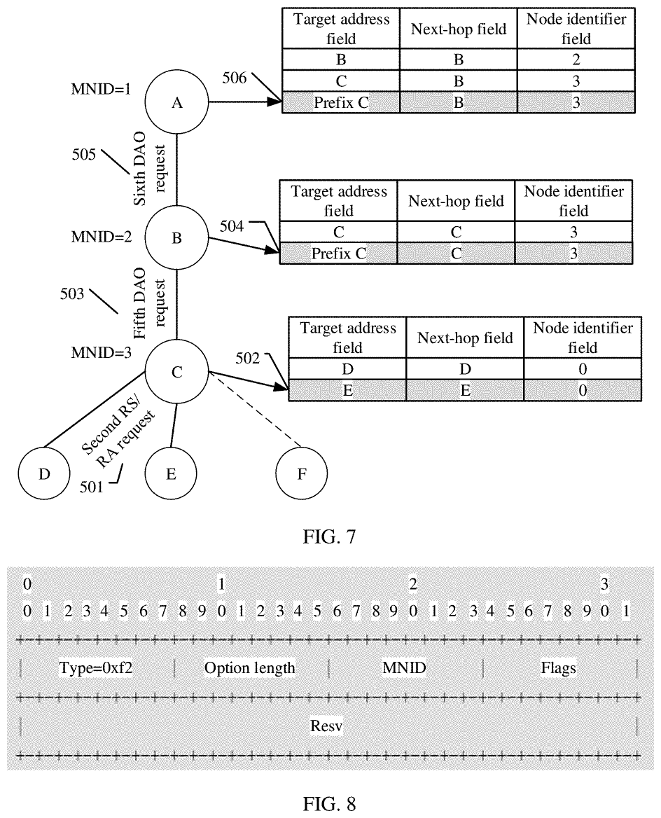

Then, the station D, the station E, and the station F sequentially request to access the mesh network. This process may be understood with reference to FIG. 6 and FIG. 7.

As shown in FIG. 6, the process includes the following steps.

401: The station D sends a first RS/RA request to the node C, where the first RS/RA request is used for requesting to access the node A, the node B, and the node C.

402: The node C generates a C-D route entry.

In FIG. 6, MNID=0 in the C-D route entry indicates that the station D does not have an MNID value.

403: The node C sends a third DAO request, where the third DAO request is used for requesting to establish an A-D route, and the third DAO request includes the identifier MNID=3 of the node C.

404: The node B receives the third DAO request, and generates a B-D route entry based on the identifier MNID=3 of the node C.

A prefix (Prefix C) of the node C is generated according to the foregoing rule, where the prefix (Prefix C) may be represented as: The prefix C (80 bits)=an IPv6 address prefix of the node C (64 bits)+0xff (8 bits)+MNID (8 bits). An MNID value of a node identifier field of the B-D route entry is modified to 3.

Before generating the B-D route entry, the node B searches for a route entry including the prefix (Prefix C), and performs step 404 only when determining that the route entry does not exist.

405: The node B sends a fourth DAO request to the node A, where the fourth DAO request is used for requesting to establish the A-D route, and the fourth DAO request includes the identifier MNID=3 of the node C.

406: The node A generates an A-D route entry based on the identifier MNID=3 of the node C.

The rule for generating a prefix on the node A is the same as the rule for generating a prefix on the node B, and the prefix C is the same as that in step 404.

Before generating the A-D route entry, the node A searches for a route entry including the prefix (Prefix C), and performs step 406 only when determining that the route entry does not exist.

When the station E accesses the mesh network, as shown in FIG. 7, the process includes the following steps.

501: The station E sends a second RS/RA request to the node C, where the second RS/RA request is used for requesting to access the node A, the node B, and the node C.

502: The node C generates a C-E route entry.

In FIG. 7, MNID=0 in the C-E route entry indicates that the station E does not have an MNID value.

503: The node C sends a fifth DAO request, where the fifth DAO request is used for requesting to establish an A-E route, and the fifth DAO request includes the identifier MNID=3 of the node C.

504: The node B receives the fifth DAO request, determines, based on the identifier MNID=3 of the node C, a B-D route entry that already includes the prefix C, and reuses the B-D route entry.

The node B may generate the prefix (Prefix C) of the node C according to the foregoing rule based on the MNID=3 in the fifth DAO request, and then find, based on the prefix C, the route entry including the prefix C, or may find the prefix C in the target address field based on the MNID=3, where the prefix C includes the MNID=3.

505: The node B sends a sixth DAO request to the node A, where the sixth DAO request is used for requesting to establish the A-E route, and the sixth DAO request includes the identifier MNID=3 of the node C.

506: The node A determines, based on the identifier MNID=3 of the node C, the B-D route entry that already includes the prefix C, and reuses the B-D route entry.

The node A may generate the prefix (Prefix C) of the node C according to the foregoing rule based on the MNID=3 in the sixth DAO request, and then find, based on the prefix C, the route entry including the prefix C, or may find the prefix C in the target address field based on the MNID=3, where the prefix C includes the MNID=3.

A process in which the station F accesses the wireless mesh network is basically the same as a process in which the station E accesses the wireless mesh network. Details are not described herein again.

It can be learned from the foregoing process that, the node A and the node B need to store only one route entry for the stations D, E, and F. In other words, the stations D, E, and F connected to the node C may reuse one route entry. This reduces storage space occupied for storing route entries of the STAs.

In the scenarios shown in FIG. 4 to FIG. 7, the DAO requests and the DAO-ACKs or GACKs each have an extended MNID option field. As shown in FIG. 8, the MNID option field may include an option type (Option Type) field, an option length (Option Length) field, an MNID (MNID) field, a flags (flags) field, and a reserved (resv) field.

Option type: 0xf2. If the option type field includes 0xf2, it indicates that an MNID needs to be read. If the option type field does not include 0xf2, it indicates that the requests or the acknowledgments are not related to the MNID. The MNID field has 8 bits and ranges from 1 to 255, and 0 is an invalid value. The flags field identifies a status of the MNID. If the flags field is represented by 0, it may indicate that the first identifier is not updated, and an MNID value of the node A, the MNID value of the node B, and the MNID value of the node C are still original 1, 2, and 3. If the flags field is represented by 1, it indicates that the MBR is restarted, and the MBR updates an MNID value of the node A, the MNID value of the node B, and the MNID value of the node C. For example, the MNID value of the node A, the MNID value of the node B, and the MNID value of the node C are updated to 4, 5, and 6 respectively. In this case, the node A, the node B, and the node C need to read the updated values 4, 5, and 6. The original first identifier is replaced with the updated second identifier in respective buffers and corresponding route entries, that is, 1 is replaced with 4, 2 is replaced with 5, and 3 is replaced with 6. Certainly, the function indicated when the flags field is 0 or 1 herein is merely an example for description, and may alternatively be indicated by using another value or character. This is not limited in this application.

Optionally, the route information storage method provided in this embodiment of this application further includes: The first node restarts before receiving the routing request; and the first node replaces the first identifier with a second identifier after receiving the routing request from the second node.

The wireless mesh network is used as an example. Considering that the MBR may be restarted due to a fault, generally, after the MBR is restarted, a unique identifier is reallocated to each second node under the MBR. Regardless of whether the first node is an MBR or an MG, after obtaining a new unique identifier, the first node uses the new unique identifier to update a corresponding route entry. In this case, if the second node still uses an original first identifier when sending the routing request, after receiving the routing request, the first node replaces the first identifier with a reallocated new second identifier, and then uses the second identifier to perform a subsequent corresponding step of searching for a route entry. This possible embodiment can avoid a problem that a route entry cannot be searched after an MBR is restarted.

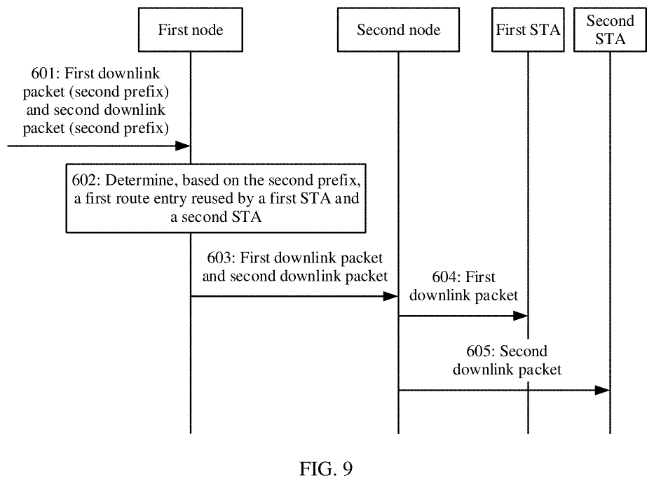

Optionally, as shown in FIG. 9, a route information storage method provided in an embodiment of this application further includes the following steps.

601: The first node receives a first downlink packet and a second downlink packet.

The first downlink packet includes a media access control (media access control, MAC) address of the first STA and a second prefix, the second downlink packet includes a MAC address of the second STA and the second prefix, and the second prefix is the same as content of the target address field of the first route entry.

602: The first node determines, based on the second prefix, the first route entry reused by the first STA and the second STA.

The first node stores only one route entry, that is, the first route entry, for the first STA and the second STA.

Optionally, step 602 includes: The first node searches target address fields in a route table based on the second prefix, to determine the first route entry whose content of the target address field is the same as the second prefix.

603: The first node sends the first downlink packet and the second downlink packet to the second node based on the first route entry.

604: The second node sends the first downlink packet to the first STA.

The second node sends the first downlink packet to the first STA based on the MAC address of the first STA.

605: The second node sends the second downlink packet to the second STA.

The second node sends the second downlink packet to the second STA based on the MAC address of the second STA.

In this embodiment, for downlink packets sent to different STAs, the first node may use a same route entry for sending, and the first node needs to store only one route entry for the different STAs. This reduces storage space occupied for storing route entries of the STAs.

The embodiment corresponding to FIG. 9 may also be referred to as a packet sending method, and the method is applied to the foregoing mesh network.

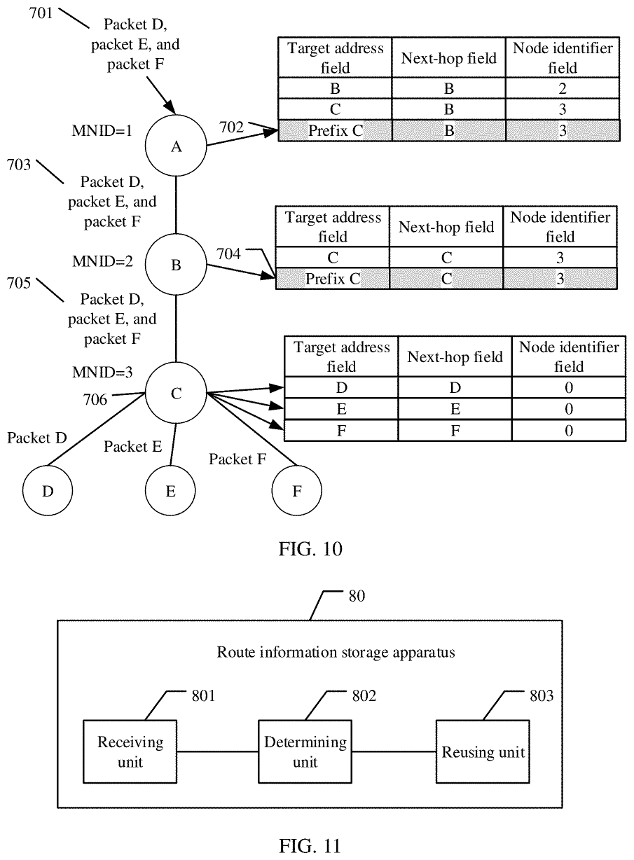

For ease of understanding, a process of sending the foregoing downlink packets is further described with reference to FIG. 10.

As shown in FIG. 10, a process of the packet sending method provided in this embodiment of this application includes the following steps.

701: The node A receives a packet D, a packet E, and a packet F.

The packet D includes a station prefix C and a MAC address of the station D, the packet E includes a station prefix C and a MAC address of the station E, and the packet F includes a station prefix C and a MAC address of the station F.

702: The node A determines, based on the prefix C, a route entry whose target address field includes the prefix C.

703: The node A sends the packet D, the packet E, and the packet F to the node B based on the route entry including the prefix C.

704: After receiving the packet D, the packet E, and the packet F, the node B determines, based on the prefix C, a route entry whose target address field includes the prefix C.

705: The node B sends the packet D, the packet E, and the packet F to the node C based on the route entry including the prefix C.

706: After receiving the packet D, the packet E, and the packet F, the node C sends the packet D to the node D based on a C-D route entry, sends the packet E to the node E based on a C-E route entry, and sends the packet F to the node F based on a C-F route entry.

It can be learned from the description of this embodiment that the node A and the node B each need to store only one route entry for the stations D, E, and F, to send packets to different stations. This reduces storage space.

The foregoing describes the mesh network and the method in embodiments of this application. The following describes an apparatus in embodiments of this application with reference to the accompanying drawings. The apparatus is applied to the first node in the foregoing embodiment.

FIG. 11 is a schematic diagram of an embodiment of a route information storage apparatus according to an embodiment of this application.

As shown in FIG. 11, an embodiment of the route information storage apparatus 80 provided in an embodiment of this application includes:

a receiving unit 801, configured to receive a routing request from the second node, where the routing request is used for requesting the first STA to access the first node, and the routing request includes a first identifier for indicating the second node;

a determining unit 802, configured to determine, based on the first identifier in the routing request received by the receiving unit 801, a first route entry corresponding to a station connected to the second node, where the first route entry corresponds to the second STA; and a reusing unit 803, configured to reuse the first route entry determined by the determining unit 802 as a route entry of the first STA.

In embodiments of this application, for the at least two STAs under the same second node, the same first route entry may be reused on the first node, and only one route entry needs to be stored for all the STAs under the same second node. This reduces storage space occupied for storing route entries of the STAs.

Optionally, the determining unit 802 is configured to generate a first prefix based on the first identifier and at least a part of an address of the second node; and determine, based on the first prefix, the first route entry corresponding to a station connected to the second node, where the first route entry includes a field the same as the first prefix.

Optionally, the determining unit 802 is configured to search a route table based on the first identifier, to determine the first route entry corresponding to a station connected to the second node, where a target address field of the first route entry includes the first identifier.

Optionally, the first identifier is located in a node identifier field of the first route entry.

Optionally, the first identifier is located in an option field of the routing request.

Optionally, the first node is a mesh border router MBR, and the apparatus 80 further includes:

an allocation unit, configured to allocate the first identifier to the second node before the receiving unit receives the routing request; and

a first generation unit, configured to generate a second route entry from the MBR to the second node, where the second route entry includes the first identifier allocated by the allocation unit.

Optionally, the first node is a mesh gate MG, and the apparatus further includes a second generation unit;

the receiving unit 801 is further configured to receive the first identifier from a mesh border router MBR; and

the second generation unit is configured to generate a third route entry from the MG to the second node, where the third route entry includes the first identifier received by the receiving unit 801.

Optionally, the apparatus further includes:

a restarting unit, configured to restart before the receiving unit receives the routing request; and

a replacement unit, configured to replace the first identifier with a second identifier after the receiving unit receives the routing request from the second node.

Optionally, the apparatus further includes a sending unit;

the receiving unit 801 is further configured to receive a first downlink packet and a second downlink packet, where the first downlink packet includes a media access control MAC address of the first STA and a second prefix, the second downlink packet includes a MAC address of the second STA and the second prefix, and the second prefix is the same as content of the target address field of the first route entry;

the determining unit 802 is further configured to determine, based on the second prefix, the first route entry reused by the first STA and the second STA; and

the sending unit is configured to send the first downlink packet and the second downlink packet to the second node based on the first route entry determined by the determining unit 802.

It should be noted that related content of the route information storage apparatus 80 may be understood with reference to related descriptions in the method embodiment. Details are not described herein again.

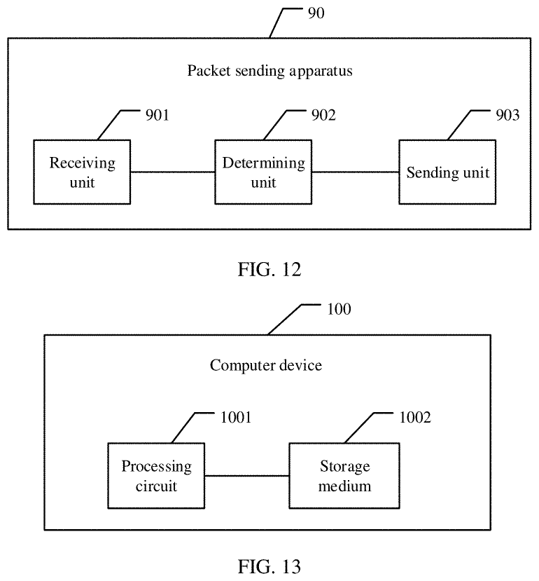

FIG. 12 is a schematic diagram of an embodiment of a packet sending apparatus according to an embodiment of this application.

As shown in FIG. 12, the packet sending apparatus 90 provided in an embodiment of this application is applied to the first node of the foregoing mesh network, and an embodiment of the apparatus 90 includes:

a receiving unit 901, configured to receive a first downlink packet and a second downlink packet, where the first downlink packet includes a MAC address of the first STA and a second prefix, the second downlink packet includes a MAC address of the second STA and the second prefix, and the second prefix is the same as content of the target address field of the first route entry;

a determining unit 902, configured to determine, based on the second prefix received by the receiving unit 901, the first route entry reused by the first STA and the second STA, where the first route entry corresponds to each STA under the second node; and

a sending unit 903, configured to send the first downlink packet and the second downlink packet to the second node based on the first route entry determined by the determining unit 902.

In this embodiment of this application, for downlink packets sent to different STAs, the first node may use a same route entry for sending, and the first node needs to store only one route entry for the different STAs. This reduces storage space occupied for storing route entries of the STAs.

Optionally, the determining unit 902 is configured to search target address fields in a route table based on the second prefix, to determine the first route entry whose content of the target address field is the same as the second prefix.

FIG. 13 is a schematic diagram of a possible logical structure of a computer device 100 according to an embodiment of this application. The computer device may be a process in which the foregoing route information storage apparatus 80 performs the foregoing route information storage method, or may be a process in which the foregoing packet sending apparatus 90 performs the foregoing packet sending method. The computer device 100 includes a processing circuit 1001 and a storage medium 1002. The processing circuit 1001 is electrically connected to the storage medium 1002. In this embodiment of this application, the processing circuit 1001 is configured to manage an action of the computer device 100. For example, the processing circuit 1001 is configured to perform steps 201 to 202 in FIG. 3, steps 303, 304, 306, 308, 404, 406, 504, and 506 in FIG. 4 to FIG. 7, step 602 in FIG. 9, and/or another process of the technology described in this specification. The storage medium 1002 is configured to store program code and data of the computer device 100.

The processing circuit 1001 may be a general-purpose processing circuit, a digital signal processing circuit, an application-specific integrated circuit, a field programmable gate array or another programmable logic device, a transistor logic device, a hardware component, or any combination thereof. The processing circuit may implement or execute various example logical blocks, modules, and circuits described with reference to content disclosed in this application. The processing circuit 1001 may alternatively be a combination for implementing a computing function, for example, a combination including one or more microprocessing circuits, or a combination of a digital signal processing circuit and a microprocessing circuit.

In another embodiment of this application, a computer-readable storage medium is further provided. The computer-readable storage medium stores computer-executable instructions. When at least one processing circuit of a device executes the computer-executable instructions, the device performs the route information storage method and the packet sending method described in embodiments in FIG. 3 to FIG. 10.

In another embodiment of this application, a computer program product is further provided. The computer program product includes computer-executable instructions, and the computer-executable instructions are stored in a computer-readable storage medium. At least one processing circuit of a device may read the computer-executable instructions from the computer-readable storage medium, and the at least one processing circuit executes the computer-executable instructions, so that the device performs the route information storage method and the packet sending method described in embodiments in FIG. 3 to FIG. 10.

In another embodiment of this application, a chip system is further provided. The chip system includes a processing circuit, configured to support a route information storage apparatus in implementing functions in the route information storage method and the packet sending method described in embodiments in FIG. 3 to FIG. 10. In a possible design, the chip system may further include a memory. The memory is configured to store program instructions and data that are necessary for the route information storage apparatus or the packet sending apparatus. The chip system may include a chip, or may include a chip and another discrete component.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of embodiments of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in embodiments of this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate parts may or may not be physically separate, and parts displayed as units may or may not be physical units, may be located in one location, or may be distributed on a plurality of network units. Some or all of the units may be selected based on actual requirements to achieve the objective of the solutions of embodiments.

In addition, functional units in embodiments of this application may be integrated into one processing unit, each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes various media that can store program code, such as a USB flash drive, a removable hard disk, a read-only memory (Read-Only Memory, ROM), a random access memory (Random Access Memory, RAM), a magnetic disk, or an optical disc.

What is claimed is:

1. A route information storage method, wherein the method is applied to a mesh network, the mesh network comprises a first node, a second node, and at least two stations (STAs), the first node is an upper-level node of the second node, the at least two STAs comprise a first STA and a second STA, the first STA and the second STA are connected to the second node, and the method comprises:
receiving, by the first node, a routing request from the second node, wherein the routing request is used for requesting the first STA to access the first node, and the routing request comprises a first identifier for indicating the second node;
determining, by the first node based on the first identifier, a first route entry corresponding to a station connected to the second node, wherein the first route entry corresponds to the second STA; and
reusing, by the first node, the first route entry as a route entry of the first STA.

2. The method according to claim 1, wherein the determining, by the first node based on the first identifier, a first route entry corresponding to a station connected to the second node comprises:
generating, by the first node, a first prefix based on the first identifier and at least a part of an address of the second node; and
determining, by the first node based on the first prefix, the first route entry corresponding to a station connected to the second node, wherein the first route entry comprises a field the same as the first prefix.

3. The method according to claim 1, wherein the determining, by the first node based on the first identifier, a first route entry corresponding to a station connected to the second node comprises:
searching, by the first node, a route table based on the first identifier, to determine the first route entry corresponding to a station connected to the second node, wherein a target address field of the first route entry comprises the first identifier.

4. The method according to claim 1, wherein the first identifier is located in a node identifier field of the first route entry.

5. The method according to claim 1, wherein the first identifier is located in an option field of the routing request.

6. The method according to claim 1, wherein the first node is a mesh border router (MBR), and the method further comprises:
allocating, by the MBR, the first identifier to the second node; and
generating, by the MBR, a second route entry from the MBR to the second node, wherein the second route entry comprises the first identifier.

7. The method according to claim 1, wherein the first node is a mesh gate MG, and the method further comprises:
receiving, by the MG, the first identifier from a mesh border router MBR; and
generating, by the MG, a third route entry from the MG to the second node, wherein the third route entry comprises the first identifier.

8. The method according to claim 1, wherein the first identifier uniquely identifies the second node in the mesh network.

9. The method according to claim 1, wherein the method further comprises:
restarting, by the first node, before receiving the routing request; and
replacing, by the first node, the first identifier with a second identifier after receiving the routing request from the second node.

10. The method according to claim 1, wherein the method further comprises:
receiving, by the first node, a first downlink packet and a second downlink packet, wherein the first downlink packet comprises a media access control (MAC) address of the first STA and a second prefix, the second downlink packet comprises a MAC address of the second STA and the second prefix, and the second prefix is the same as content of the target address field of the first route entry;
determining, by the first node based on the second prefix, the first route entry reused by the first STA and the second STA; and
sending, by the first node, the first downlink packet and the second downlink packet to the second node based on the first route entry.

11. A first node for route information storage, and the first node comprises: a memory and at least one processor, wherein the memory is coupled to the at least one processor; and
the memory stores program instructions, and when the program instructions are run by the processor, the at least one processor is enabled to perform the following steps:
receive, a routing request from the second node, wherein the routing request is used for requesting a first STA to access the first node, and the routing request comprises a first identifier for indicating the second node, wherein the first STA and a second STA are connected to the second node;
determine, based on the first identifier, a first route entry corresponding to a station connected to the second node, wherein the first route entry corresponds to the second STA; and
reuse, the first route entry as a route entry of the first STA.

12. The first node according to claim 11, wherein further cause the at least one processor to:
generate a first prefix based on the first identifier and at least a part of an address of the second node; and
determine, based on the first prefix, the first route entry corresponding to a station connected to the second node, wherein the first route entry comprises a field the same as the first prefix.

13. The first node according to claim 11, wherein further cause the at least one processor to:
search, a route table based on the first identifier, to determine the first route entry corresponding to a station connected to the second node, wherein a target address field of the first route entry comprises the first identifier.

14. The first node according to claim 11, wherein the first identifier is located in a node identifier field of the first route entry.

15. The first node according to claim 11, wherein the first identifier is located in an option field of the routing request.

16. The first node according to claim 11, wherein the first node is a mesh border router (MBR), and wherein further cause the at least one processor to:
allocate the first identifier to the second node; and
generate a second route entry from the MBR to the second node, wherein the second route entry comprises the first identifier.

17. A computer-readable storage medium, storing one or more instructions that, when the computer-readable storage medium is on a first node, when the medium is executed by at least one processor, cause the at least one processor to:
receive, a routing request from a second node, wherein the routing request is used for requesting a first STA to access the first node, and the routing request comprises a first identifier for indicating the second node, wherein the first STA and a second STA are connected to the second node;
determine, based on the first identifier, a first route entry corresponding to a station connected to the second node, wherein the first route entry corresponds to the second STA; and
reusing, the first route entry as a route entry of the first STA.

18. The computer-readable storage medium according to claim 17, further cause the at least one processor to:
generate, a first prefix based on the first identifier and at least a part of an address of the second node; and
determine based on the first prefix, the first route entry corresponding to a station connected to the second node, wherein the first route entry comprises a field the same as the first prefix.

19. The computer-readable storage medium according to claim 17, further cause the at least one processor to:
search, a route table based on the first identifier, to determine the first route entry corresponding to a station connected to the second node, wherein a target address field of the first route entry comprises the first identifier.

20. The computer-readable storage medium according to claim 17, wherein the first node is a mesh border router (MBR), and further cause the at least one processor to:
allocate, the first identifier to the second node; and
generate, a second route entry from the MBR to the second node, wherein the second route entry comprises the first identifier.
